(19) United States
(12) Patent Application Publication
(10) Pub. No.: US 2010/0173159 A1
(43) Pub. Date: Jul. 8, 2010

(54) Four-layered spherical ceramics for frying oil

(76) Inventor: Toshikuni Takashi, Honolulu, HI (US)

Correspondence Address: Toshikuni Takashi, 2215 Aloha Drive # 11L, Honolulu, HI, 96815, US

(21) Appl. No.: 12/319,427

(22) Filed: Jan. 8, 2009

(51) Int. Cl. B32B 5/16

(52) U.S. Cl. 428/404

(57) ABSTRACT

This invention provides a technique which even in an environment without light or with little light irradiation, achieves potent reduction, reduces, by a photocatalytic effect, the oxidation and deterioration of oil when used in edible oil used for fried foods, improves the state of fried foods, attains excellent frying even at lower temperature, exhibits the effect for a long time, has an ability to recycle waste oil as biofuel, and is excellent in food safety. Although a photocatalyst itself is extremely effective outdoors with much ultraviolet light or when an ultraviolet light emitting light is used, the photocatalyst cannot exhibit its functions indoors, in oil in a fryer, or in water. This invention provides a durable reduced photocatalyst which can exhibit significant photocatalytic functions in oil in a fryer, in water, or in the dark, to exert its long-lasting effect. The object is achieved by a functional oil oxidation-inhibiting 4-layered spherical ceramics, wherein a 4-layered spherical composition consisting of 4 mixtures that are a mixture consisting of powdery soil clay and powdery anion active core ceramics solidified and formed into a first layer core, a mixture consisting of powdery soil clay and powdery titanium oxide solidified and formed into a second layer core, a ceramic mixture consisting of powdery soil clay and powdery activated charcoal solidified and formed into a layer, and a mixture consisting of platinum powder and titanium oxide adhered on the surface of the ceramic mixture, is used in dipping in edible oil.

### BACKGROUND OF THE INVENTION

1. Field of the Invention

The present invention relates to a multifunctional technique wherein ceramic compositions formed into 4 layers different in material from one another are thermally formed and used to heat edible oil, thereby inhibiting the oxidation and deterioration of edible oil, improving a finished state of food materials after cooking, and enabling frying at lower temperature than conventional, by generating a potent photocatalytic effect in a state free of light or a state with little light, and enables waste oil to be recycled as biofuel, thus contributing to the global environment. The conventional photocatalysts function only in a place with strong ultraviolet light during daylight or in a place with a UV lamp, and do not exhibit their effects until a long time of several months is given. The present invention is based on two types of photocatalyst techniques wherein one is an electromagnetic wave-responsive photocatalyst consisting of a combination of an anion active natural radiation ore and titanium oxide, and the other is a photoelectrochemical photocatalyst consisting of a combination of noble metal platinum and titanium oxide, thereby utilizing their synergetic effect, and can show a potent photocatalytic effect in the dark or in a dark liquid even in a short time, and can maintain a photocatalytic effect for a long time. Up to now, there has been no ceramics composition consisting of a combination of the two.

2. Description of the Related Art

Deterioration of frying oil for deep-fried foods and fries proceeds with the length of time, and thus there is a problem that a fried state of food materials after frying is unfavorable and becomes less crisp, and the oil itself turns dark, gives out a foul smell and becomes increasingly unfavorably sticky. Because of a cooking-oil price hike, many traders are put in a difficult position, but must cope with increasing demand in the future by suppressing the oxidation of edible oil to make the oil usable for a long time. Disposal of waste oil gives unfavorable burden on the environment.

There are measures for coping with such problems, and inventions are also proposed.

Examples include a process for producing foods by using a catalyst as well as an agent for treating edible oil in JP-A 2002-142672, an antioxidant for edible oil, an oxidation preventing instrument, and a cleaning instrument in JP-A 2004-000107, and an agent for preventing deterioration of edible oil in JP-A 2000-063881, all of which use titanium to attain effects to some degrees, but because spraying of fine powder of titanium oxide is used as a film formation technique, there is a disadvantage that the resulting titanium film is peeled off in several months due to deterioration at 180° C. at which frying oil is usually used.

Any of these prior arts seem to be effective only in prolonging the usable time of oil against deterioration and in improving fried states, but with respect to heat efficiency, there is no technical improvement in the conventional frying temperature of deep-fried food and fried food; specifically, there is still none of techniques wherein even at a temperature lower by about 10% than 180° C. which has been conventionally regarded as the optimum frying temperature, foods can be fried to levels equal to or higher than at 180° C.

### SUMMARY OF THE INVENTION

An object of the present invention lies not only in clearing conventionally solved problems as a matter of course, in achieving stabilization, such as keeping the state of oil more hardly deteriorated than by the conventional disclosed techniques and achieving, even at frying temperatures lower than conventional, fried states equal to or higher than in the conventional techniques, as well as in solving recycle technology for waste oil, but also in exhibiting the photocatalytic effect of titanium oxide even in a dark environment by a novel means, and in forming a strong catalyst not shown in the related art.

### DESCRIPTION OF THE PREFERRED EMBODIMENTS

The ceramics of the present invention is an epoch-making means not proposed in related inventions, which can solve the unsolved problems with the constitutive principle by which 2 photocatalytic actions, that is, the magnetic wave-responsive photocatalytic action of anions and titanium oxide and the photoelectrochemical photocatalytic action of noble metal platinum and titanium oxide, and an oxidation inhibiting action, a redox action, and an active oxygen activating action can be simultaneously exhibited.

Ceramics-mixed sphere (A) that has formed a first layer core by solidifying a mixture of a first layer core powdery soil clay and powder anionic active ceramics are characterized by having a function in generating a large amount of anions mainly.

Specifically, ceramics-mixed sphere (A) consists of 75 to 80% by weight of earth clay having a particle size of 1 to 50 μm and 20 to 25% by weight of powdery anion active natural radioactive ore having a particle size of 1 to 50 μm, characterized by having a function in mainly generating a large amount of anions (contact ion measurement: about 3500 to 4000 anions) from the first layer core ceramics-mixed sphere.

The sphere (A) has a function in further clustering oil during generation of a large amount of anions.

The external layer of the first layer core anion ceramics-mixed sphere, on which a mixture of a second layer core consisting of powdery solid clay and powdery titanium oxide was solidified and stacked, exerts a photocatalytic effect strongly by the synergistic effect thereof with the titanium oxide-mixed sphere.

Specifically, the second layer core consists of 75 to 80% by weight of earth clay having a particle size of 1 to 50 μm and 20 to 25% by weight of powdery anion titanium oxide having a particle size of 1 to 50 μm which is formed as an external layer on the first layer core to constitute a second layer core of ceramics-mixed sphere (B), characterized by making its redox photocatalytic action potent by the influence of the anion radiation with the anion mixed sphere core in the first layer core.

The function is also made potent even when the photocatalytic function of titanium oxide in the external layer of the anion active natural radioactive ore, even in a light-free state.

A mixture consisting of powdery soil clay and powdery activated charcoal in a third layer core is further stuck as an external layer on the ceramic mixture of the titanium oxide mixed sphere in the second layer core, and as an external layer on the titanium oxide mixed sphere in the second layer core, functions as an aid for the strong reduction action of the photocatalyst.

Specifically, the third layer core consists of 75 to 80% by weight of powdery earth clay having a particle size of 1 to 50 μm and 20 to 25% by weight of powdery activated charcoal having a particle size of 1 to 50 μm which are formed as an external layer on the second layer to constitute a third layer core of ceramics mixed sphere (C), and functions as an aid to enhance the photocatalytic function, particularly the reducing power, of the titanium oxide mixture in the second layer core.

The third layer core functions in enhancing and assisting the reduction power action in the photocatalyst functions of titanium oxide.

A ceramic composition (D), that is, a mixture of powdery soil clay, a powdery noble metal platinum, and powdery titanium oxide, which is further stuck as a fourth external layer, thereby forming mixed spheres of 4 layers consisting of the fourth layer and the 3 layers described above, followed by thermally forming at 900 to 1200° C., has a photocatalyst function.

Specifically, a ceramic composition consisting of 75 to 80% by weight of powdery soil clay having a particle size of 1 to 50 μm, 3 to 5% by weight of powdery noble metal platinum having a particle size of 1 to 50 μm, and 15 to 20% by weight of powdery titanium oxide having a particle size of 1 to 50 μm, which is formed as a fourth external layer and thermally formed at 900 to 1200° C., brings about double photocatalyst functions.

The ceramics of the present invention is characterized by having features such as potent redox reduction action, long-term catalytic performance duration, and rapid action in a state without light or a state with little light, by using the 4-layered composition.

One of the biggest problems to be solved is that it could be confirmed that in cooking and heating of foods with frying oil, the photocatalytic function inherent in titanium oxide can function even under a dark and night-vision state by the catalytic function of a mixture of noble metal platinum and titanium oxide in the fourth layer by irradiating the titanium oxide layer in the second layer, with the radiation wavelength emitted from radiation ore thorium in the first layer core.

As described above, usually titanium oxide has been estimated to produce a photocatalytic effect by irradiation with UV light higher than visible light, but electromagnetic waves having higher energy than UV light can also be used. In this invention, however, it could be confirmed that radiations of higher energy than electromagnetic waves can be used to more effectively attain the photocatalyst effect of titanium oxide.

A titanium oxide film has been formed mainly by vapor deposition, sputtering, high-speed blasting of titanium oxide powder, or plasma spraying of titanium oxide, but the present invention is characterized in that titanium oxide was formed in the 4-layered spherical ceramics.

The ceramics sphere in which the mixed sphere (A), the mixed sphere (B), the mixture (C), and the composition (D) were formed into a 4-layer structure sphere is a novel means characterized by the double photocatalytic functions of the spherical ceramic, which is achieved with the electromagnetic wave-responsive catalytic performance of titanium oxide in the second layer core by the anion generation function of the first layer core, with the reducing power enhancing function by activated charcoal in the third layer core, and with the photoelectrochemical catalytic function by titanium oxide and noble metal platinum in the fourth layer as an external layer, and the ceramics sphere can be expected to be usable in frying oil for cooking in order to prevent oil deterioration.

According to the present invention, anions can be generated from the mixed sphere in (A) above to form oil into smaller clusters, thus improving heat conductivity during heating and cooking of intended foods fried with oil, thereby bringing about a recognized effect of improving the state of fries, reducing the frying time, and relatively reducing the amount of oil adhered to foodstuffs.

The titanium oxide mixture (B) enhances the influence of the anion-releasing natural stone mixture in (A) above, that is, the inhibitory effect on oxidation and deterioration of oil by the electromagnetic wave-responsive photocatalytic function and the redox power by reduction of the oxidation-reduction potential (ORP) of oil and stabilizes the oil temperature, thereby improving heat efficiency and improving heat conduction in fried foodstuffs thus enabling reduction in frying time and in drying temperature, so that the deterioration of oil is delayed and fuel can be effectively saved, and thus this technical effect can also contribute as countermeasure against global warming.

The activated charcoal in (C) above has an effect of reducing oxidation-reduction potential (ORP), and functions in further enhancing the photocatalytic effect in (A) and (B) above. Originally, titanium oxide is not effective without irradiation with electromagnetic waves of higher than visible light, but the wavelength vibration of radiations from the inside gives rise to the photocatalytic effect and active oxygen activating effect of titanium oxide even in cooking oil for drying or in a fuel tank, under an environment in the dark, thus bringing about reduction in deterioration of oil and a thermal conduction promoting effect.

The mixture of titanium oxide and noble metal platinum in (D) above has significant photocatalytic functions even under a dark or light-deficient environment, and similarly to the photocatalytic functions in (A) and (B) above, exerts an effect of delaying deterioration of oil.

The spherical ceramics composition formed into the 4 layers (A), (B), (C), and (D) above in the method of forming titanium oxide has a very strong photocatalytic effect because titanium oxide is 2-layered in (B) and (D) above.

Because the same fried state of foodstuffs can be achieved by the 4-layered ceramics even when the frying temperature is lower by 5 to 10% than usual, the present invention has also an effect significantly contributing to saving of fuel costs and also an effect of reducing generation of formaldehyde that is a carcinogen.

In the 4-layered ceramic composition, the anion ceramics promote clustering of oil and thus have a significant maintenance effect so that vapor washing once a month suffices.

According to the synergistic effect described above, waste fats and oils to finally become waste oil can be mixed with light oil and used as fuel for a diesel engine, thus yielding a technical effect that can also contribute to global environment.

The 4-layered spherical ceramics composition is characterized in that it is housed in a stainless steel net or in a stainless steel container having air permeability through punched holes, then dipped in a fryer made of stainless steel or another metal filled with oil capable of heating for deep-frying or frying and in cooking oil for frying in a frying container, and used by heating as it is.

The means of forming photocatalytic titanium oxide is thermal burning carried out with spherical ceramics.

As other means of forming titanium oxide film, techniques such as vacuum deposition, sputtering, and Metallikon spraying can be used to form titanium oxide film, but because the oil temperature in a fryer is a temperature as high as about 180° C. to 200° C., the titanium oxide film formed by the above techniques is peeled off in 2 to 3 months, and thus the 4-layered spherical ceramics are most preferable and were recognized to be durable for 5 years or more even in a high-speed deterioration test.

Waste oil from the above oil was mixed as biofuel in light oil etc. and could be used in a diesel engine in a combustion engine.

It was confirmed in NSF International, Chicago, US, that no harmful substance was detected in the 4-layered spherical ceramics. The 4-layered spherical ceramics have been certified by NSF.

It was confirmed in Japan Food Research Laboratories that no harmful substance was detected in the 4-layered spherical ceramics.

In Japan Food Research Laboratories, the 4-layered spherical ceramics was examined in a test of residual chlorine in tap water, and it was recognized that after 24 hours, about 85 to 90% residual chlorine was adsorbed and decomposed.

The 4-layered spherical ceramics were examined in Chemicals Evaluation and Research Institute that is an inspection institute under the jurisdiction of Ministry of Economy, Trade and Industry, Japan, to indicate that the oxidation speed of oil was decreased and the usable time of the oil was doubled.

The 4-layered spherical ceramics were subjected to an oxidation inhibition test for edible oil in Japan Food Research Laboratories, to indicate that the deterioration speed of oil was decreased and the usable time of the oil was doubled. From this result, it is judged that oil exchange when assumed to be conducted usually once a week may be conducted once every 2 weeks if the 4-layered spherical ceramics are used.

In Japan, Canada, and the US too, a test of suppression of deterioration of edible oil was conducted in many restaurants, and it was thereby demonstrated that the usable time of oil was doubled.

It has been reported that in certain deep-fried food restaurants, the temperature of frying oil is set usually at 185° C., but when the 4-layered spherical ceramics are used, 170° C. suffices. The amount of oil adhered to food is reduced, thus making dried food crisp and attaining a lower calorific value, which is also advantageous to health.

What is claimed is:

1. A multifunctional, oil oxidation-inhibiting 4-layered spherical ceramics, wherein a composition comprising 4 mixtures consisting of a ceramic mixture prepared by spherically solidifying and forming a first layer core mixture consisting of powdery anion-generating natural radioactive mineral and powdery soil clay, a ceramic mixture prepared by solidifying and forming a second layer core mixture consisting of powdery soil clay and powdery titanium oxide, a ceramic mixture prepared by solidifying and forming a third layer core mixture consisting of powdery soil clay and powdery activated charcoal, and a mixture consisting of powdery soil clay, a powdery noble metal platinum and powdery titanium oxide formed as an external layer on the surface of the third layer core ceramic mixture is thermally burned into a 4-layer structure shape etc. and used in dipping in oil.

2. The inorganic material used in the oil oxidation-inhibiting agent of the present invention is preferably at least one member selected from the group consisting of a ceramic material (clay), a vitreous material, silica, zeolite, and activated earth. The inorganic material may be a mixture of two or more thereof.

3. The multifunctional oil oxidation-inhibiting 4-layered spherical ceramics according to claim 1, wherein 4 compositions consisting of a ceramic composition formed as a first layer core from a mixture consisting of 75 to 80% by weight of powdery ceramic clay soil and 20 to 25% by weight of powdery anion active natural radiation-emitting ore, a ceramic composition formed as a second layer core from a mixture consisting of 75 to 80% by weight of powdery soil clay and 20 to 25% by weight of powdery titanium oxide, a ceramic composition formed as a third layer core from a mixture consisting of 75 to 80% by weight of powdery soil clay and 20 to 25% by weight of powdery activated charcoal, and a composition formed as a fourth external layer from a mixture consisting of 75 to 80% by weight of powdery soil clay, 3 to 5% by weight of a powdery noble metal platinum, and 15 to 20% by weight of powdery titanium oxide, which have been thermally formed at about 900 to 1200° C., are arranged in the respective layers and used in dipping in oil.

4. The multifunctional 4-layered spherical ceramics according to any of claims 1 to 3, wherein the particle sizes of the powders are from 1 to 50 μm.

5. The multifunctional 4-layered spherical ceramics according to any of claims 1 to 4, wherein carriers of the ceramics are in the form of balls, pellets, plates or cylinders.

6. The multifunctional 4-layered spherical ceramics according to any of claims 1 to 5, wherein the multifunctional 4-layered spherical ceramics are housed in an air-permeable container that is not problematic even when the mixtures in the form of balls, pellets, plates and cylinders are dipped in oil heated at high temperature.

7. The multifunctional 4-layered spherical ceramics according to any of claims 1 to 6, wherein the first layer core is an anion-generating natural radioactive ore thorium (Th).

8. The multifunctional 4-layered spherical ceramics according to any of claims 1 to 7, wherein the second layer core is titanium oxide (TiO₂).

9. The multifunctional 4-layered spherical ceramics according to any of claims 1 to 8, wherein the third layer core is activated charcoal.

10. The multifunctional 4-layered spherical ceramics according to any of claims 1 to 9, wherein the fourth external layer is a noble metal platinum (Pt) and titanium oxide (TiO₂).

11. The multifunctional 4-layered spherical ceramics according to any of claims 1 to 3, wherein the oil is edible oil.

12. The multifunctional 4-layered spherical ceramics according to claim 11, wherein the edible oil is vegetable frying oil for cocking.

13. The multifunctional 4-layered spherical ceramics according to claim 11 or 12, wherein waste oil from the oil is used as biofuel.

14. The multifunctional 4-layered spherical ceramics according to claim 13, wherein the biofuel is used in a combustion engine.

15. The multifunctional 4-layered spherical ceramics according to claim 13 or 14, wherein the biofuel is used in a diesel engine.

16. The multifunctional 4-layered spherical ceramics according to any of claims 1 to 15, wherein the 4-layered spherical ceramics is used in an oil tank for combustion-engine fuel using fossil fuel.
